(19) United States
(12) Patent Application Publication
(10) Pub. No.: US 2009/0078364 A1
(43) Pub. Date: Mar. 26, 2009

(54) Method and Device for Performing Transfer Printing on Printed Sheets of Paper

(75) Inventors: Toshio Yamashita, Kanazawa (JP); Katsushi Hirokawa, Fuchu (JP); Takahiko Nakamura, Fuchu (JP)

Correspondence Address: THE WEBB LAW FIRM, P.C., 700 KOPPERS BUILDING, 436 SEVENTH AVENUE, PITTSBURGH, PA, 15219, US

(73) Assignee: RYOBI LTD., Fucho (JP)

(21) Appl. No.: 12/233,351

(22) Filed: Sep. 18, 2008

(30) Foreign Application Priority Data
Sep. 20, 2007 (JP) 2007-243808

(51) Int. Cl. B65C 9/18; B65C 9/26; B32B 37/00

(52) U.S. Cl. 156/238; 156/391; 156/378

(57) ABSTRACT

There is provided a method and a device for performing transfer printing on printed sheets of paper, capable of reliably transferring patterns at predetermined positions on the printed sheets. The device includes a transfer section that conveys a transfer film while conveying the printed sheets and repeatedly transfers patterns of the transfer film onto the printed sheets. A tension adjusting part that adjusts tension on the transfer film is provided to transfer the patterns of the transfer film at the predetermined positions on the printed sheets.

### CROSS REFERENCE TO RELATED APPLICATION

This application claims priority from Japanese Patent Application No. 2007-243808, which is incorporated herein by reference.

### BACKGROUND OF THE INVENTION

1. Field of the Invention

The present invention relates to a technique of transferring gold foil, embossed patterns, hologram patterns, and the like on printed sheets of paper by pressing a transfer film thereon, thereby to increase added value of the printed surfaces, and more particularly, to a method and a device directed to transfer printing on printed sheets of paper for transferring patterns of a transfer film at predetermined positions on the printed sheets in the transfer printing.

2. Related Art

There is proposed a gloss finishing apparatus for providing added value to printed sheets of paper in the above-mentioned manner. The apparatus includes a varnishing unit that applies an ultraviolet curable resin varnish (also simply referred to as “a varnish”) onto the printed sheets of paper printed in a printing unit and a hologram forming unit of an endless type that presses a transfer film onto the printed sheets of paper varnished in the varnishing unit to transfer patterns of the transfer film thereon. With this apparatus, the hologram surface of the endlessly moving transfer film is impressed onto the surface of each of the successively fed printed sheets, whereby the patterns are transferred on the printed sheets (e.g., see Japanese Unexamined Patent Publication No. 2006-315229 (cf. FIGS. 1 and 2).

In the gloss finishing apparatus according to Japanese Unexamined Patent Publication No. 2006-315229, while the transfer film of an endless reel is pressed onto printed sheets every time a sheet is fed, the apparatus does not include a structure adapted to match the positions of the patterns of the transfer film to be transferred onto the printed sheets to predetermined positions, which makes the apparatus hard to use, being unable to transfer the patterns at predetermined positions on the printed sheets or to transfer the patterns at the same position on every printed sheet.

It may be possible to roughly decide positions to be transfer-printed at manually tuned timing, and then to transfer the patterns of the transfer film at approximately the same positions on multiple printed sheets; however, the transfer-printed positions on the printed sheets sometimes change over time, and no means for correcting the change is provided, which poses a significant problem in using the apparatus, thus calling for improvement.

### SUMMARY OF THE INVENTION

In order to overcome the foregoing problems, it is an object of the present invention to provide a method and a device for performing transfer printing on printed sheets of paper, capable of reliably transferring patterns at predetermined positions on the printed sheets.

According to one aspect of the present invention, there is provided a method of performing transfer printing on a printed sheet of paper, the method including: conveying the printed sheet of paper; conveying a transfer film; and transferring a pattern of the transfer film onto the printed sheet in a repetitive manner, wherein the transfer film is applied with tension in such a manner that the tension is adjusted to stretch and contract the transfer film in a conveying direction thereof, and thereby the pattern of the transfer film is transferred at a predetermined position on the printed sheet.

According to another aspect of the present invention, there is provided a device for performing transfer printing on a printed sheet of paper, the device including a transfer section that conveys the printed sheet of paper as well as a transfer film and transfers a pattern of the transfer film onto the printed sheet in a repetitive manner, and a tension adjusting part that applies tension to the transfer film and adjusts the tension on the transfer film, to transfer the pattern of the transfer film at a predetermined position on the printed sheet.

Since the conveying speed of the transfer film can be accelerated and decelerated through the adjustment of tension on the transfer film, the patterns of the transfer film can be transferred at predetermined positions on the fed printed sheets.

The patterns to be transferred onto the printed sheets may include embossed patterns, hologram patterns, as well as gold foil.

Marks provided on the transfer film at predetermined intervals may be used so that an interval between the marks is detected, and the tension adjustment may be performed when the interval is outside a predetermined interval.

An adjustment range of the tension on the transfer film may be set from an upper limit at which the film no longer stretches and a lower limit at which the film loosens, and in a case where a position of the film fails in being matched with respect to the printed sheet within the adjustment range, a feeding speed of the film may be accelerated or decelerated.

The transfer film may be provided with marks at predetermined intervals, and the device may further include: a position detecting part that detects an interval between the marks; a determining part that determines whether or not the interval detected at the position detecting part is equal to a predetermined interval; and a driving part that drives and controls the tension adjusting part when the determining part determines a mismatch between the detected interval and the predetermined interval. In a case where the interval detected at the position detecting part is outside a predetermined interval, the driving part may drive and control the tension adjusting part to automatically carry out the tension adjustment.

The tension adjusting part may be made up of a pair of first rollers on a leading end side in a feeding direction of the transfer film, a pair of second rollers on a terminal end side in the feeding direction of the transfer film, and electric motors that drive at least two of the rollers respectively wherein the two electric motors are driven in such a manner that a difference in rotation speed is produced between the first rollers and the second rollers, to adjust the tension on the transfer film.

The device may further include a synchronous operation controlling part that changes the rotation speed of the pair of first rollers in accordance with a change in conveying speed of the printed sheet after an adjustment by the tension adjusting part, and also changes the rotation speed of the pair of second rollers by a degree that corresponds to the change in rotation speed of the first rollers.

There can be provided a method and a device for matching the position of a transfer film with respect to printed sheets of paper, capable not only of reliably transferring patterns of the transfer film at predetermined positions on fed printed sheets by adjusting tension on the transfer films but also of reliably transferring the patterns at desired positions on the printed sheets even in a case where the positions of the patterns relative to the printed sheets deviate, by immediately correcting the positions through the adjustment of tension.

The marks provided on the transfer film at predetermined intervals are used so that an interval between the marks is detected, and in a case where the interval is outside a predetermined interval, the tension adjustment is performed; with this configuration, deviation of the position of a pattern can be immediately recognized, and the position can be corrected through the tension adjustment.

In the case where the position of the film cannot be matched relative to the printed sheets within the adjustment range, the feeding speed of the film is accelerated or decelerated, so that the position matching control can advantageously be continued, and the transfer operation can be performed efficiently.

In the case where the tension adjusting part is made up of the pair of first rollers on the leading end side in the feeding direction of the transfer film, the pair of second rollers on the terminal end side in the feeding direction of the transfer film, and the electric motors that drive at least two of the rollers respectively, wherein the tension on the transfer film is adjusted by driving the two electric motors in such a way that a difference in rotation speed is produced between the first rollers and the second rollers, it is possible to downsize the device as compared with, e.g., a device that includes a stretching and contracting mechanism configured to adjust tension by operating a pair of rollers in the stretching/contracting direction of a transfer film.

In the case where the device includes the synchronous operation controlling part that changes the rotation speed of the pair of first rollers in accordance with a change in conveying speed of the printed sheets after an adjustment by the tension adjusting part, as well as the rotation speed of the second rollers by a degree that corresponds to the change in rotation speed of the first rollers, the rotation speed of the second rollers can be changed likewise with the change in rotation speed of the first rollers, and even when the conveying speed of the printed sheets has changed, the transfer operation can be performed with the position of the transfer film matched to the positions of the printed sheets without deviation at all times.

### BRIEF DESCRIPTION OF THE DRAWINGS

The above, and other objects, features and advantages of the present invention will become apparent from the detailed description thereof in conjunction with the accompanying drawings wherein.

FIG. 1 is a schematic side view of a sheet-fed printing press;

FIG. 2 is a side view of a transfer section;

FIG. 3 is a plan view of a transfer film; and

FIG. 4 is a control block diagram for matching the positions of a sheet of paper and of the transfer film.

### DESCRIPTION OF THE PREFERRED EMBODIMENTS

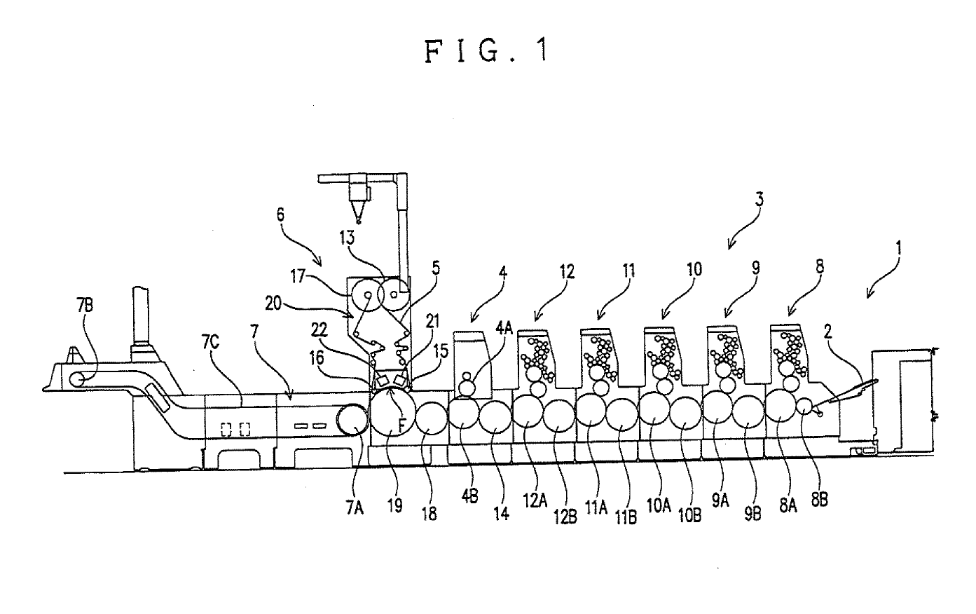

FIG. 1 shows an example of a printing press incorporating a transfer device 6 capable of treating the printed surfaces of printed sheets of paper by varnishing and gloss-finishing the printed surfaces with a resin varnish and transferring thereon gold foil, embossed patterns, hologram patterns, and the like. This printing press includes a sheet feeder section 1, a printer section 3, a varnish applicator section 4, a transfer section F, and a sheet discharge section 7. The sheet feeder section 1 feeds sheets of paper 2 one sheet at a time by means of a feeder device, a sheet separator device, and the like from a sheet stack table. The printer section 3 performs five-color printing on the sheets 2 fed from the sheet feeder section 1. The varnish applicator section 4 applies (coats) an ultraviolet curable resin varnish (also simply referred to as “a varnish”) onto the sheets 2 that have been printed in the printer section 3. The transfer section F presses a transfer film 5 made of a stretchable material with restoring force (e.g., polyethylene terephthalate, so-called PET; other materials may also be used), onto the ultraviolet curable resin varnish over the sheets 2 that have been applied with the ultraviolet curable resin varnish at the varnish applicator section 4, thereby treating the surfaces of the sheets 2. The sheet discharge section 7 discharges the sheets 2 whose surfaces have been treated at the transfer section F. Although the printer section 3 includes five printing units 8, 9, 10, 11, and 12 so that five-color printing can be performed in the present embodiment, the printer section may be one capable of printing other colors than five colors, such as a single color or more than one colors. In addition, while the sheet discharge section 7 is constructed of a chain conveyor device with grippers, the printing press may not include the sheet discharge section 7, and the specific structure of each section constituting the printing press is not limited to that shown in the figure. Also, while sheets of paper are used as the printed sheet herein, the printed sheet may be a continuous elongate sheet. Further, the transfer device 6 may be built in the printing press to be used therein, whilst the transfer device 6 may not be built in the printing press and may be used as a single independent unit.

In the case of attaching gold foil to the printed surfaces, a foil applicator called a toiler is used to press printed material, so that gold foil is peeled off from a substrate onto a portion with an adhesive material (or may be varnish) of the printed material attached thereto. The printed surfaces may also be applied with something other than gold foil.

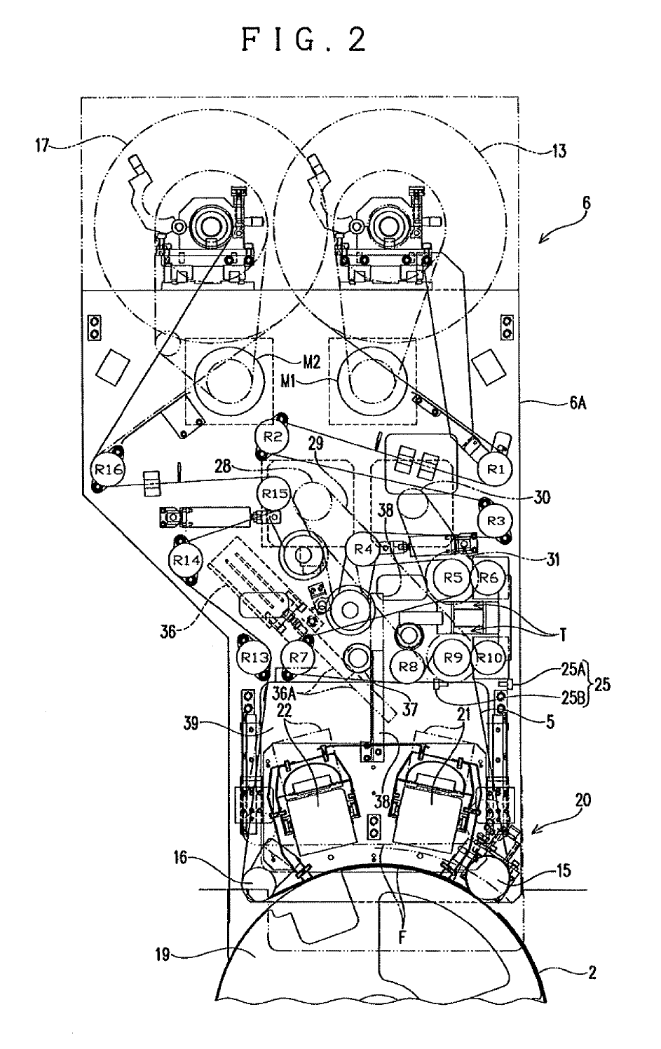

The printing units 8 to 12 include, respectively, printing impression cylinders 8A to 12A as well as delivery cylinders 8B to 12B on the respective upstream sides of the printing impression cylinders 8A to 12A in a conveying direction, for delivering sheets 2 to the printing impression cylinders. The delivery cylinder 8B that has a smaller diameter and locates at the leading end in the conveying direction out of the delivery cylinders 8B to 12B is also referred to as a sheet feeder cylinder, and this delivery cylinder 8B, together with the feeder device, sheet separator device, and the like, constitutes the sheet feeder section 1. Although not shown in the figure, each of the impression cylinders 8A to 12A and the delivery cylinders 9B to 12B is provided with grippers, each having a jaw block and a gripping jaw to grip a fed sheet 2, at two positions (although only one position is shown in FIG. 2, one gripper may be provided at a single position or more than two grippers may be provided at more than two positions) in a circumferential direction. Although not shown, the delivery cylinder 8B of a smaller diameter is provided with a gripper having a jaw block and a gripping jaw to grip a sheet 2, at a single position in the circumferential direction. Also, the varnish applicator section 4 includes a varnishing cylinder 4A from which the ultraviolet curable resin varnish is supplied and an impression cylinder 4B that is located opposite to the varnishing cylinder 4A and coats the ultraviolet curable resin varnish over the printed sheets 2.

A delivery cylinder 14 is provided to deliver sheets 2 to the impression cylinder 4B. Although not shown, each of these cylinders 14 and 4B is also provided with grippers, each having a jaw block and a gripping jaw to grip a fed sheet 2, at two positions (one gripper may also be provided at a single position or more than two grippers may also be provided at more than two positions) in the circumferential direction, as with the above cylinders.

As shown in FIGS. 1 and 2, the transfer device 6 includes an impression cylinder 19 and a film transfer mechanism 20. The impression cylinder 19 receives sheets 2 from a delivery cylinder 18 that is provided to receive the sheets 2 from the impression cylinder 4B. The film transfer mechanism 20 presses the transfer film 5 onto the sheets 2 on the impression cylinder 19 to perform transfer printing thereon. The film transfer mechanism 20 is a processing means for processing sheets 2 and this film transfer mechanism 20 presses the transfer film 5 onto the sheets 2 to transfer gold foil, embossed patterns, hologram patterns, and the like from the transfer film 5 onto the sheets 2 while utilizing, as an adhesive agent, the ultraviolet curable resin varnish that has been applied at the varnish applicator section 4. The transfer film 5 is pressed onto the ultraviolet curable resin varnish over the sheets 2, so that the surfaces applied with the ultraviolet curable resin varnish can be smoothened and the surfaces are made even glossier. Then, ultraviolet irradiating lamps 21 and 22 (may be one or more than two) irradiate ultraviolet rays from above to the pressed film 5 to cure the ultraviolet curable resin varnish. The delivery cylinder 18 is also provided with grippers for gripping sheets 2 at two positions (one gripper may be provided at a single position or more than two grippers may be provided at more than two positions) in the circumferential direction, as with the above cylinders. The impression cylinder 19 is a so-called triple-diameter cylinder that has a larger diameter than the delivery cylinder 18 and is provided with grippers at three positions (not shown) in the circumferential direction, as with the above cylinders; therefore, the delivery cylinder 18 rotates 1.5 times while the impression cylinder 19 rotates a single time, whereby a sheet 2 can be passed to a gripper on the impression cylinder 19 from a gripper on the delivery cylinder 18 as described above. The impression cylinder 19 having a larger diameter (triple-diameter cylinder) than the other cylinders advantageously ensures a larger drying zone for the irradiation of ultraviolet rays as well as a longer distance from the varnish applicator section 4, but the impression cylinder 19 may have the same diameter as the other cylinders.

As shown in FIGS. 1 and 2, the transfer device 6 includes a feed roll 13, two (may be one or more than two) pressing rollers 15 and 16, and a windup roll 17. The feed roll 13 is capable of winding up the transfer film 5 as well as feeding the transfer film 5. The pressing rollers 15 and 16 press the transfer film 5 fed from the feed roll 13 onto the sheets (printed sheet) 2 on the impression cylinder 19. The windup roll 17 winds up the transfer film 5, which is peeled off from the printed sheets after being pressed by the pressing rollers 15 and 16. In FIG. 2, between the feed roll 13 and the pressing roller 15 on the upstream side in the conveying direction out of the two pressing rollers 15 and 16 provided are film guiding rollers R1 to R10, among which the rollers R9, R10 and R5, R6 are rollers of a tension adjustment part T to be described later. Between the pressing roller 16 on the downstream side in the conveying direction out of the two pressing rollers 15 and 16 and the windup roll 17 provided are film guiding rollers R13 to R16. The roller R4 is a tension roller that is provided on the feed side to apply predetermined tension. The roller R15 is a tension roller that is provided on the windup side to apply predetermined tension. The pressing roller 16 on the downstream side in the conveying direction is disposed at a position that is spaced upward from the impression cylinder 19 a set distance, because the film 5 can thereby be separated (peeled off) smoothly from the sheets 2; however, the pressing roller 16 may pressingly contact the impression cylinder 19. The feed roll 13 is rotatably driven with the power of an electric motor M1 for the feed roll, and the windup roll 17 is rotatably driven with the power of an electric motor M2 for the windup roll. While a total of four electric motors, i.e., the two electric motors M1 and M2 and two electric motors 28 and 30 for rotatably driving operation to be described later, are basically operated in synchronization with one another, these motors are configured such that the rotation speeds thereof, which sometimes cause loosening or excessive tension in the transfer film 5, are controlled so as to favorably eliminate such loosening or excessive tension. In addition to the above configuration in which the transfer film 5 fed from the feed roll 13 is wound onto the windup roll 17, rolls may be so disposed as to endlessly convey the film 5.

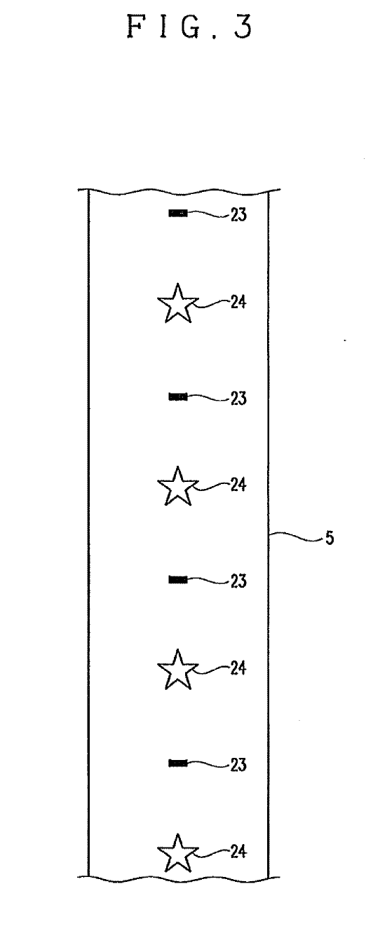

The transfer device 6 includes a device for matching the position of the transfer film with respect to the sheets so that the patterns of the transfer film can be transferred at predetermined positions on the fed sheets 2. Specifically, as shown in FIG. 3, black-colored marks 23 for use in position detection are coated on the transfer film 5 made of a thin, transparent and colorless sheet at predetermined intervals; however, patterns 24 that are lined longitudinally on the shown transfer film 5 and provided between the marks 23 may be used as the marks, or in the case where, e.g., the transfer film is formed of a number of linked films, the linked portions (translucent portions) may be used as the marks. Also, although the shown patterns 24 are all identical to one another, the patterns may be different from one another. Further, the patterns may be provided over the entire area of the transfer film, in addition to the structure in which the patterns are provided only on portions among the marks.

As shown in FIG. 2, an optoelectronic sensor 25 including a photo-emitting part 25A and a photo-receiving part 2513 is disposed, with the photo-emitting surface and the photo-receiving surface located opposite to each other with the transfer film 5 interposed therebetween, at a position (a position on the film feed side spaced a set distance from the point where the film transfer is started) directly downstream the tension adjusting part T to be described later.

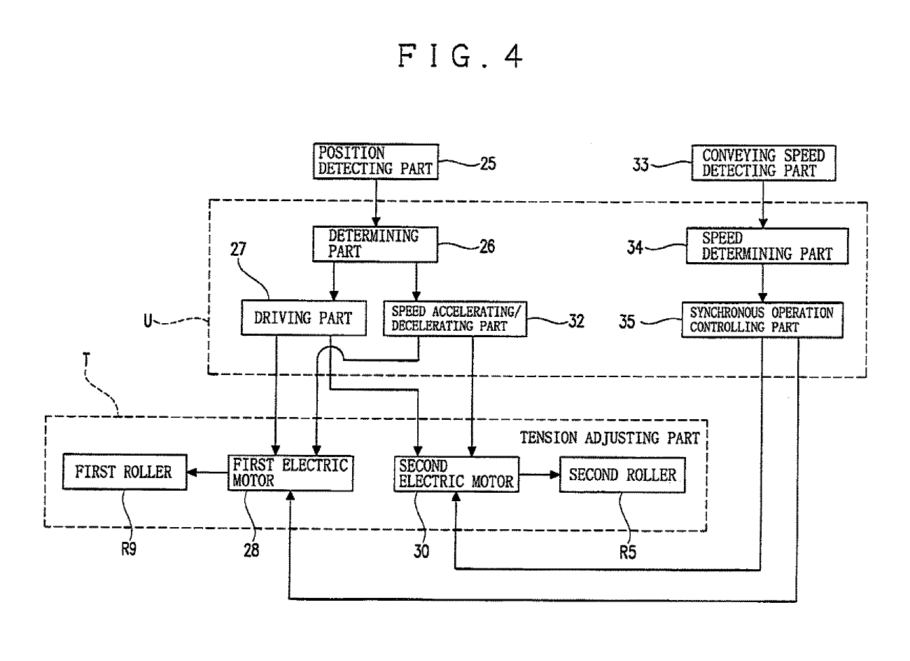

Further, as shown in FIG. 4, a determining part 26 and a driving part 27 are provided. The determining part 26 detects an interval (distance) between the marks by counting a time from the detection of a mark to the detection of a subsequent mark, at the optoelectronic sensor 25, and determines whether or not the interval is equal to a predetermined interval that is stored in advance. The driving part 27 drives and controls the tension adjusting part to be described later when the determining part 26 has determined a mismatch between the detected interval and the predetermined interval. Accordingly, the driving part 27 drives the tension adjusting part T so as to control tension on the transfer film 5, which allows the transfer film 5 to be pressed by the pressing rollers 15 and 16 with, e.g., a mark 23 on the transfer film 5 matched to the leading end position (may be set to any position) in the conveying direction of the sheets 2. That is, the patterns 24 can be transferred at predetermined positions that have been set in advance on the sheets 2. The determining part 26 and the driving part 27 are provided in a controller U of a computer.

The tension adjusting part T includes the pair of first rollers R9 and R10, the pair of second rollers R5 and R6, and the electric motors 28 and 30. The first rollers R9 and R10 are disposed side by side horizontally (may be disposed in any way) on the starting end (leading end) side in the feeding direction of the transfer film 5. The second rollers R5 and R6 are disposed side by side horizontally (may be disposed in any way) on the terminal end side in the feeding direction of the transfer film 5. The electric motors 28 and 30 drive the two rollers R9 and R5, respectively. Accordingly, the electric motors 28 and 30 are driven through the driving part 27 such that, in a case where the interval between the marks 23 that have been detected at the position detecting part 25 is longer than a predetermined interval, the rotation speed of the first rollers R9 and R10 is adjusted to be substantially equal to the rotation speed of the second rollers R5 and R6, and in a case where the detected interval is shorter than the predetermined interval, the rotation speed of the second rollers R5 and R6 is adjusted to be slower than the rotation speed of the first rollers R9 and R10, in which way the part for adjusting tension on the transfer film 5 is configured. Since the tension adjustment as described above is performed, the pitch among the marks 23 is set smaller than the size of the sheets 2 in the conveying direction; meanwhile, since the transfer film 5 is stretched by the tension adjusting part T when fed, the rotation speed of the second rollers R5 and R6 is set slightly slower than the rotation speed of the first rollers R9 and R10. Through the above-described tension adjustment, the position of the transfer film 5 is adjusted relative to the sheets 2.

More specifically, a pulley of the first roller R9 is interlockingly operated with a pulley of the first electric motor 28 through a timing belt 29 (may be chain interlock or gear interlock), and the drive of the first electric motor 28 is controlled, whereby the rotation speed of the first roller R9 can be changed. Further, as with the first roller R9, the second roller R5 is designed, such that a pulley of the second roller R5 is interlockingly operated with a pulley of the second electric motor 30 through a timing belt 31 (may be chain interlock or gear interlock), and the drive of the second electric motor 30 is controlled, whereby the rotation speed of the second roller R5 can be changed. In the case where the tension is adjusted using the tension adjusting part T configured as above, for instance, the marks 23 on the transfer film 5 are sequentially detected, namely the interval between two marks 23 or the time from the detection of a mark to the passage of a subsequent mark is calculated by a calculating part (not shown) included in the controller U, and the determining part 26 compares the calculated interval between the marks 23 or the time taken for the passage with an interval or a time taken for passage that has been stored in advance; in the case of mismatch, e.g., in the case where the detected interval or time is shorter than the interval or time stored in advance, the determining part 26 determines that the conveying speed of the transfer film 5 is too fast, and deceleration signals are outputted from the driving part 27 to the second electric motor 30 so as to decelerate the rotation speed of the second roller R5 with respect to the rotation speed of the first roller R9. In contrast, in the case where the determining part 26 determines the speed is too slow, acceleration signals are outputted from the driving part 27 to the second electric motor 30 so as to accelerate the rotation speed of the second roller R5. While the present embodiment illustrates an example of driving only the rollers R9 and the R5, which are ones of the pairs of rollers R9 and R10 and rollers R5 and R6, both the paired rollers may be driven. The conveying speed of the transfer film 5 is controlled in the above-described manner, thereby matching the sheets 2 and the transfer film 5 in time at the position where a sheet 2 that has been received by a gripping jaw of the impression cylinder 19 meets the transfer film 5. In place of the impression cylinder 19, it is possible to use a belt conveyor, a roller conveyer, or the like.

The range of the tension adjustment performed by the tension adjusting part T is set from an upper limit at which the film 5 can no longer stretch to a lower limit at which the film 5 loosens. If the intervals among the marks cannot be matched to the predetermined interval within the adjustment range, namely, only by means of the speed difference between the rotation speed of the first roller R9 and that of the second roller R5, a speed accelerating/decelerating part 32 included in the controller U accelerates/decelerates the feeding speed of the film 5. In other words, the conveying speed of the transfer film 5 is merely caused to be slower or faster than a predetermined speed with the adjustment by the driving part 27 alone, and the intervals among the marks cannot be matched to the predetermined interval no matter how long the time passes. Even in such a case, the intervals can be matched to each other through acceleration signals and deceleration signals outputted from the speed accelerating/decelerating part 32 to the first and second electric motors 28 and 30. When the acceleration signals or deceleration signals outputted to the first and second electric motors 28 and 30 successfully make the intervals among the marks match the predetermined interval, the driving part 27 drives and controls the tension adjusting part T to return to the tension adjustment control. The determination that the intervals among the marks cannot be matched to the predetermined interval may be made in such a case that the intervals among the marks were unable to be matched to the predetermined interval even when the tension adjustment by the tension adjusting part T was performed twice (may be more than twice). While the example herein shows the case in which the tension adjustment is automatically controlled based on the information detected by the position detecting part 25, the speed of the electric motor 30 may be adjusted through manual operation when deviation of the transferred positions of the transfer film on the printed sheets is visually confirmed, or alternatively, the visual confirmation may be conducted by the position detecting part 25, and based on the information detected by the position detecting part 25, the speed of the electric motor 30 may be adjusted through manual operation.

As shown in FIG. 4, a speed determining part 34 included in the controller U determines that the conveying speed sent from a conveying speed detecting part 33, which detects the conveying speed of the sheets 2, has changed after an adjustment by the tension adjusting part T. Upon the determination, the rotation speed of the pair of first rollers R9 and R10 is changed in accordance with the change in speed, and the rotation speed of the second rollers R5 and R6 is changed by a degree that corresponds to the change in the rotation speed of the first rollers R9 and R10, which processes are performed by a synchronous operation controlling part 35. Even in the case where the conveying speed of the sheets 2 has changed as mentioned above, the synchronous operation controlling part 35 outputs acceleration signals to the first and second electric motors 28 and 30, so that the feeding speed of the film 5 is matched to the conveying speed of the sheets 2.

As shown in FIG, 2, the transfer section F, which is comprised of the pressing rollers 15 and 16 and the transfer film 5 carried between the pressing rollers 15 and 16, is freely movable between a remote position (shown with a chain double-dashed line) and a proximate position (shown with a solid line) relative to the impression cylinder 19, and, e.g., in the case where the transfer operation is not performed, the transfer section F can be located at the upward-receded position.

A driving part is provided to move the transfer section F away from towards the impression cylinder 19. As shown in FIG. 2, in the driving part, an extension rod 36A of an air cylinder 36 is provided with teeth that engage with a gear 37 that is rotatably fitted to a casing 6A of the transfer device 6, and the gear 37 is rotated by the elongation and contraction of the extension rod 36A to produce torque, which torque is then converted to vertically moving force by teeth provided on a rack 38; the lower end of the rack 38 is coupled to the upper end of a support member 39 at an approximate center in the sheet-conveying direction, which support member 39 is installed with the pressing rollers 15 and 16 and the like. Accordingly; in a case where the surface treatment is not performed, the extension rod 36A of the air cylinder 36 is extended to a position shown with a chain double-dashed line in FIG. 2, thereby rotating the gear 37 counterclockwise to cause the rack 38 to move to an upward position shown with a chain double-dashed line and to raise the support member 39 to an upward position. In this manner, the transfer section F (the pressing rollers 15 and 16 as well as the transfer film 5 carried between the pressing rollers 15 and 16) can be moved away from the impression cylinder 19. In order to lower the transfer section F, the extension rod 36A of the air cylinder 36 is contracted to a position shown with a dashed line in FIG. 2, so that the transfer section F (the pressing rollers 15 and 16 as well as the transfer film 5 carried between the pressing rollers 15 and 16) can be moved close to the impression cylinder 19 (as shown with a solid line in FIG. 2). At this lowered position, the surface treatment is repeatedly performed with the transfer section F through the control to match the position of the transfer film 5 with respect to the conveyed sheets 2 in the above-described manner.

The sheet discharge section 7 includes a conveyor device for receiving the sheets 2 that have been processed in the processing devices and conveyed thereto, and conveying them to a predetermined position. The conveyor device is provided over a pair of right and left endless running chains 7C that are suspended between a pair of right and left sprockets 7A and 7B respectively. Each of the sprockets 7A and 7B is provided with grippers (although not shown, the basic structures thereof are the same as the above-described grippers) for gripping the sheets at both ends in the sheet-conveying direction (see FIG. 1).

This specification is by no means intended to restrict the present invention to the preferred embodiments set forth therein. Various modifications to the method and device for performing transfer printing, as described herein, may be made by those skilled in the art without departing from the spirit and scope of the present invention as defined in the appended claims.

What is claimed is:

1. A method of performing transfer printing on a printed sheet of paper, the method including: conveying the printed sheet of paper; conveying a transfer film; and transferring a pattern of the transfer film onto the printed sheet in a repetitive manner, wherein the transfer film is applied with tension in such a manner that the tension is adjusted to stretch and contract the transfer film in a conveying direction thereof, and thereby the pattern of the transfer film is transferred at a predetermined position on the printed sheet.

2. The method according to claim 1, wherein
marks provided on the transfer film at predetermined intervals are used so that an interval between the marks is detected, and the tension adjustment is performed when the interval is outside a predetermined interval.

3. The method according to claim 1, wherein
an adjustment range of the tension on the transfer film is set from an upper Emit at which the film no longer stretches and a lower limit at which the film loosens, and in a case where a position of the film fails in being matched with respect to the printed sheet within the adjustment range, a feeding speed of the film is accelerated or decelerated.

4. A device for performing transfer printing on a printed sheet of paper, the device including a transfer section that conveys the printed sheet of paper as well as a transfer film and transfers a pattern of the transfer film onto the printed sheet in a repetitive manner, and a tension adjusting part that applies tension to the transfer film and adjusts the tension on the transfer film, to transfer the pattern of the transfer film at a predetermined position on the printed sheet.

5. The device according to claim 4, wherein
the transfer film is provided with marks at predetermined intervals, and the device further comprises:
a position detecting part that detects an interval between the marks;
a determining part that determines whether or not the interval detected at the position detecting part is equal to a predetermined interval; and
a driving part that drives and controls the tension adjusting part when the determining part determines a mismatch between the detected interval and the predetermined interval.

6. The device according to claim 4, wherein
a range of the tension adjustment performed by the tension adjusting part is set from an upper limit at which the film no longer stretches to a lower limit at which the film loosens, and the device further comprises a speed accelerating/decelerating part that accelerates and decelerates a feeding speed of the film in a case where a position of the film fails in being matched with respect to the printed sheet within the adjustment range.

7. The device according to claim 4, wherein
the tension adjusting part is made up of a pair of first rollers on a leading end side in a feeding direction of the transfer film, a pair of second rollers on a terminal end side in the feeding direction of the transfer film, and electric motors that drive at least two of the rollers respectively, wherein the two electric motors are driven in such a manner that a difference in rotation speed is produced between the first rollers and the second rollers, to adjust the tension on the transfer film.

8. The device according to claim 7, further comprising a synchronous operation controlling part that changes the rotation speed of the pair of first rollers in accordance with a change in conveying speed of the printed sheet after an adjustment by the tension adjusting part, and also changes the rotation speed of the second rollers by a degree that corresponds to the change in rotation speed of the first rollers.
